(19) United States
(12) Patent Application Publication
(10) Pub. No.: US 2023/0292726 A1
(43) Pub. Date: Sep. 21, 2023

(54) FISHING LURE RECOVERY DEVICE

(71) Applicant: Lonnell Bellamy, Alexandria, LA (US)

(72) Inventor: Lonnell Bellamy, Alexandria, LA (US)

(21) Appl. No.: 17/697,122

(22) Filed: Mar. 17, 2022

(51) Int. Cl. A01K 97/24; A01K 99/00

(52) U.S. Cl. CPC A01K 97/24; A01K 99/00

(57) ABSTRACT

A fishing lure recovery device for a telescopic fishing net with a weight and floaters includes a net. The net has a perimeter. A weight is positioned at an end of the perimeter. A pair of floats is positioned on a respective one of a pair of sides of the perimeter. The net has a port. An end of a first section of a telescopic assembly is inserted within the port of the net to secure the net to the telescopic assembly. The first section is nested within a second section, and the second section is nested within a third section. Each of the sections of the telescopic assembly is cylindrical shaped tubes. The telescopic assembly can extend its length out by adjusting the positioning of each of the sections relative to each other.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### Field of the Invention

The disclosure relates to fishing net devices and more particularly pertains to a new fishing net device for a telescopic fishing net with a weight and floaters.

### Description of Related Art Including Information Disclosed Under 37 CFR 1.97 And 1.98.

The prior art relates to fishing net devices. Known prior art includes a variety of fishing net devices having a telescopic handle assembly. Further, the prior art includes a variety of fishing net devices having some floatation device. Known prior art lacks a fishing net device comprising a telescopic handle assembly with a detachable net having a pair of floatation devices and a weight attached to the net.

### (H) BRIEF SUMMARY OF THE INVENTION

An embodiment of the disclosure meets the needs presented above by generally comprising a net. The net is configured for straining a liquid from a solid. The net has a perimeter. A weight is positioned at an end of the perimeter. A pair of floats is positioned on a pair of sides of the perimeter. A port is positioned on the perimeter. The port has an interior. The port has a hole that defines a space for a spring pin to be positioned within. Furthermore, the embodiment comprises a telescopic assembly. The telescopic assembly comprises a first section, a second section, and a third section. The first section has an end. The end is configured for being positioned within the interior of the port of the net. The end of the first section has a hole. The spring pin is positioned within the hole of the first section. The spring pin of the first section is configured for being positioned within the hole of the port whereby attaching to the net. The first section is nested within the second section. An end of the second section has a locking ring. The locking ring of the second section is configured for retaining the first section in a fixed position relative to the second section. The second section is nested within the third section. An end of the third section has a locking ring. The locking ring of the third section is configured for retaining the second section in a fixed position relative to the third section.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### I BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is an isometric view of an extended fishing lure recovery device according to an embodiment of the disclosure.

FIG. 2 is an isometric view of a retracted embodiment of the disclosure.

FIG. 3 is an isometric view of a removed handle embodiment of the disclosure.

FIG. 4 is a bottom view of an embodiment of the disclosure.

FIG. 5 is a side view of an embodiment of the disclosure.

FIG. 6 is a front view of an embodiment of the disclosure.

FIG. 7 is a cross-sectional view of an embodiment of the disclosure taken from FIG. 6 of Line 7-7.

FIG. 8 is an in-use view of an embodiment of the disclosure.

### (J) DETAILED DESCRIPTION OF THE INVENTION

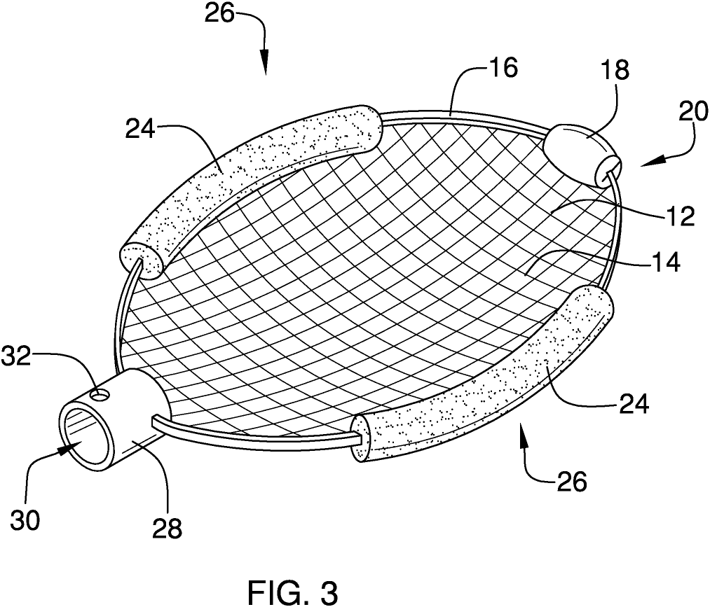

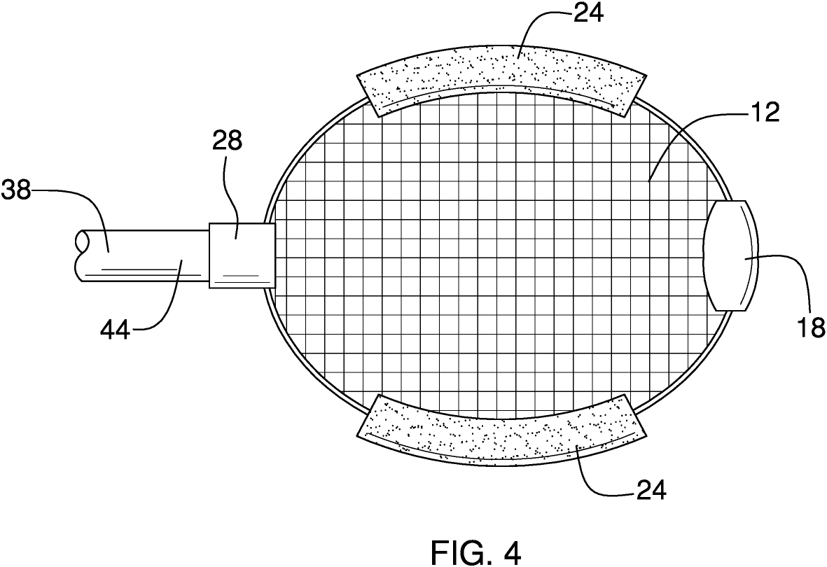

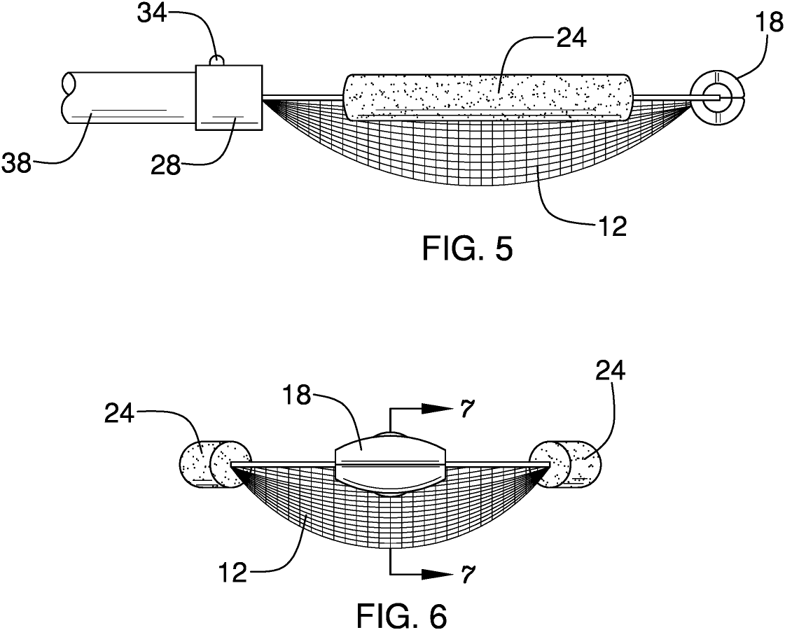

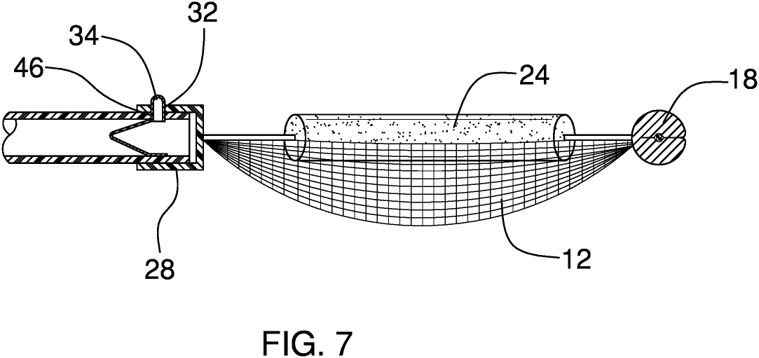

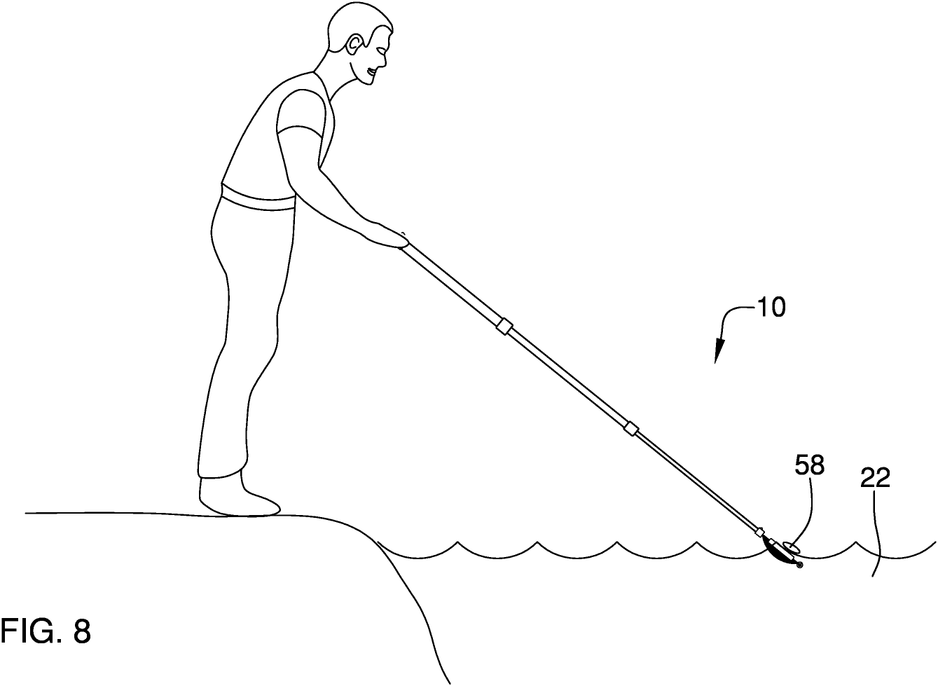

With reference now to the drawings, and in particular to FIGS. 1 through 8 thereof, a new fishing net device embodying the principles and concepts of an embodiment of the disclosure and generally designated by the reference numeral 10 will be described.

As best illustrated in FIGS. 1 through 8, the fishing lure recovery device 10 generally comprises a net 12. The net 12 is a weaving of rope with a plurality of apertures 14. The net 12 is configured for removing a liquid from a solid. The net 12 can be an existing item such as fishing netting. The net 12 has a perimeter 16. The perimeter 16 is a solid structure that gives the net a circular shape. A weight 18 is positioned at an end 20 of the perimeter 16. The weight 18 is configured for bringing the net 12 below the surface of the water 22. A pair of floats 24 is positioned on a respective one of a pair of sides 26 of the perimeter 16. The pair of floats 24 is positioned perpendicular to the weight 18 of the perimeter 16. The pair of floats 24 provides buoyancy to the net 12 and prevents the net 12 from sinking within the water 22.

A port 28 is positioned on the perimeter 16. The port 28 is positioned opposite relative to the weight 18 on the perimeter 16. The port 28 is a cylindrical shaped tube. The port 28 has an interior 30 that defines a space for an element to be stored within. The port 28 has a hole 32 that defines a space for a spring pin 34 to be lodged within. A telescoping assembly 36 comprises of a first section 38, a second section 40, and a third section 42. Each of the sections of the telescoping assembly 36 is cylindrical shaped tubes. An end 44 of the first section 38 is configured for being inserted into the interior 30 of the port 28. The end 44 of the first section 38 has a hole 46. The spring pin 34 is positioned within the hole 46 and is configured for being inserted into the hole 32 of the port 28 whereby retaining the net 12 to the telescopic assembly 36.

The first section 38 is nested within the second section 40. An end 48 of the second section 40 has a locking ring 50. The locking ring 50 has threading that is complementary to threading of the end 48 of the second section 40. When the locking ring 50 is in a loose position, the first section 38 is configured for moving along the longitudinal axis of the second section 40. When the locking ring 50 is tightened on the second section 40, then the first section 38 remains in a fixed position relative to the second section 40.

The second section 40 of the telescopic assembly 36 is nested within the third section 42, similar to how the first section 38 is nested within the second section 40. Furthermore, an end 52 of the third section 42 has a locking ring 54. The locking ring 54 of the third section 42 has threading that is complementary to threading of the end 52 of the third section 54. When the locking ring 54 is in a loose position, the second section 40 can move along the longitudinal axis within the third section 42. When the locking ring 54 is tightened on the third section 42, then the second section 40 remains in a fixed position relative to the third section 42. Additionally, the third section 42 has a handle 56. The handle 56 provides an area for the user to grasp the telescopic assembly 36 when using the fishing lure recovery device 10.

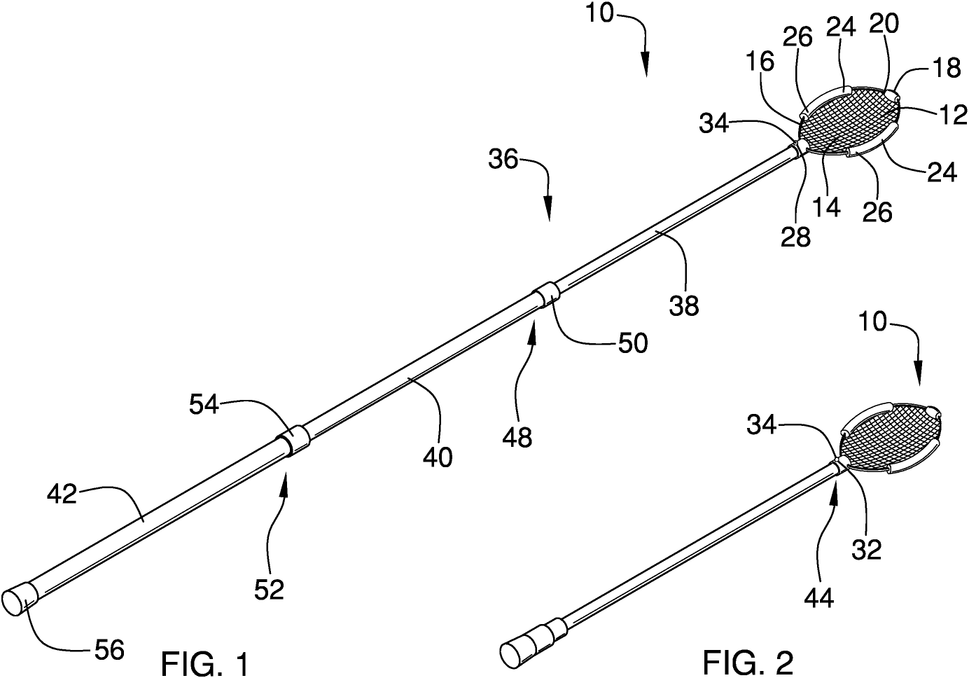

The first section 38 can be extended out from the second section 40, and the second section 40 can be extended out from the third section 42, as shown in FIG. 1. Furthermore, the first section 38 can retract within the second section 40, and the second section 40 can retract within the third section 42, as shown in FIG. 2. The net 12 can be removed from the telescopic assembly 36 by releasing the spring pin 34 from the hole 32 of the port 28 and removing the port 28 from the end 44 of the first section 38 of the telescopic assembly 36.

In use, the user positions the end 44 of the first section 38 of the telescopic assembly 36 within the interior 30 of the port 28 of the net 12. When the spring pin 34 of the first section 38 is lodged within the hole 32 of the port 28, then the net 12 is secured to the telescopic assembly 36. The telescopic assembly 36 can be extended out to increase the length of the fishing lure recovery device 10. The user can grip the telescopic assembly 36 by the handle 56 of the third section 42 and position the net 12 within the water 22 to retrieve a fishing lure 58.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing lure recovery device comprising:
a net, said net being configured for straining a solid from a liquid, said net having a perimeter, a weight being coupled directly to said perimeter, a pair of floats being positioned on a respective one of a pair of sides of said perimeter, a port being positioned on said perimeter, said weight being positioned at an end of said perimeter diametrically opposite to said port, said weight being elongated in a direction perpendicular to said port, said port having an interior, said port having a hole, said hole defining a space for a spring pin to be positioned within;
a telescopic assembly, said telescopic assembly comprising:
a first section, said first section having an end, said end being configured for being positioned within said interior of said port of said net, said end of said first section having a hole, said spring pin being positioned within said hole of said first section, said spring pin of said first section being configured for being positioned within said hole of said port whereby attaching to said net;
a second section, said first section being nested within said second section, an end of said second section having a locking ring, said locking ring of said second section being configured for retaining said first section in a fixed position relative to said second section; and
a third section, said second section being nested within said third section, an end of said third section having a locking ring, said locking ring of said third section being configured for retaining said second section in a fixed position relative to said third section.

2. The fishing lure recovery device of claim 1, further comprising said net being a weaving of rope.

3. The fishing lure recovery device of claim 2, further comprising said net having a plurality of apertures.

4. The fishing lure recovery device of claim 1, further comprising said net being a circular shape.

5. The fishing lure recovery device of claim 1, further comprising said pair of floats being positioned perpendicular relative to said weight.

6. The fishing lure recovery device of claim 1, further comprising said pair of floats being configured for providing buoyancy to said net.

7. The fishing lure recovery device of claim 1, further comprising said port being positioned opposite to said weight on said perimeter, said port being a cylindrical shaped tube.

8. The fishing lure recovery device of claim 1, further comprising said interior defining a space for an element to be stored within.

9. The fishing lure recovery device of claim 1, further comprising said first section being a cylindrical shaped tube.

10. The fishing lure recovery device of claim 9, further comprising said second section being said cylindrical shaped tube.

11. The fishing lure recovery device of claim 1, further comprising said first section being configured for moving along a longitudinal axis of said second section.

12. The fishing lure recovery device of claim 1, further comprising said locking ring having threading complementary to threading of said end of said second section.

13. The fishing lure recovery device of claim 9, further comprising said third section being said cylindrical shaped tube.

14. The fishing lure recovery device of claim 1, further comprising said second section being configured for moving along a longitudinal axis of said third section.

15. The fishing lure recovery device of claim 1, further comprising said locking ring having threading complementary to threading of said end of said third section.

16. The fishing lure recovery device of claim 1, further comprising said third section having a handle, said handle being configured for providing an area for the user to grab said telescopic assembly.

17. A fishing lure recovery device comprising:
a net, said net being a weaving of rope, said net having a plurality of apertures, said net being configured for straining a solid from a liquid, said net being a circular shape, said net having a perimeter, a weight being coupled directly to said perimeter, a pair of floats being positioned on a respective one of a pair of sides of said perimeter, said pair of floats being positioned perpendicular relative to said weight, said pair of floats being configured for providing buoyancy to said net, a port being positioned on said perimeter, said weight being positioned at an end of said perimeter diametrically opposite to said port, said weight being elongated in a direction perpendicular to said port, said port being a cylindrical shaped tube, said port having an interior, said interior defining a space for an element to be stored within, said port having a hole, said hole defining a space for a spring pin to be positioned within;
a telescopic assembly, said telescopic assembly comprising:
a first section, said first section being a cylindrical shaped tube, said first section having an end, said end being configured for being positioned within said interior of said port of said net, said end of said first section having a hole, said spring pin being positioned within said hole of said first section, said spring pin of said first section being configured for being positioned within said hole of said port whereby attaching to said net;
a second section, said second section being said cylindrical shaped tube, said first section being nested within said second section, said first section being configured for moving along a longitudinal axis of said second section, an end of said second section having a locking ring, said locking ring having threading complementary to threading of said end of said second section, said locking ring of said second section being configured for retaining said first section in a fixed position relative to said second section; and
a third section, said third section being said cylindrical shaped tube, said second section being nested within said third section, said second section being configured for moving along a longitudinal axis of said third section, and end of said third section having a locking ring, said locking ring having threading complementary to threading of said end of said third section, said locking ring of said third section being configured for retaining said second section in a fixed position relative to said third section, said third section having a handle, said handle being configured for providing an area for the user to grab said telescopic assembly.
